(19) United States
(12) Patent Application Publication
(10) Pub. No.: US 2012/0196380 A1
(43) Pub. Date: Aug. 2, 2012

(54) SYSTEM AND METHOD FOR DETECTION OF CONTAMINANTS IN AN AIRFLOW

(75) Inventors: Scott Mordin Hoyte, Fountain Inn, SC (US); Frederick Gorum Graham, III, Greenville, SC (US)

(73) Assignee: GENERAL ELECTRIC COMPANY, Schenectady, NY (US)

(21) Appl. No.: 13/018,712

(22) Filed: Feb. 1, 2011

(51) Int. Cl. G01N 31/22; G01N 1/38

(52) U.S. Cl. 436/163; 73/61.59; 422/68.1

(57) ABSTRACT

A method for detecting contaminants in an airflow includes urging an airflow from a desired source location into a volume of water. The airflow is mixed into the water, and particles are dissolved in the water. A change in a property of the volume water is measured via a detection probe, indicative of an amount of particles present in the volume of water. A system for detecting particles includes a container configured to contain a volume of water and an airflow inlet in the container configured to introduce an airflow into the volume of water from a desired source location. A detection probe is located in the container to detect changes in a selected property of the volume of water after introduction of the airflow into the volume of water thereby indicating presence of particles in the airflow.

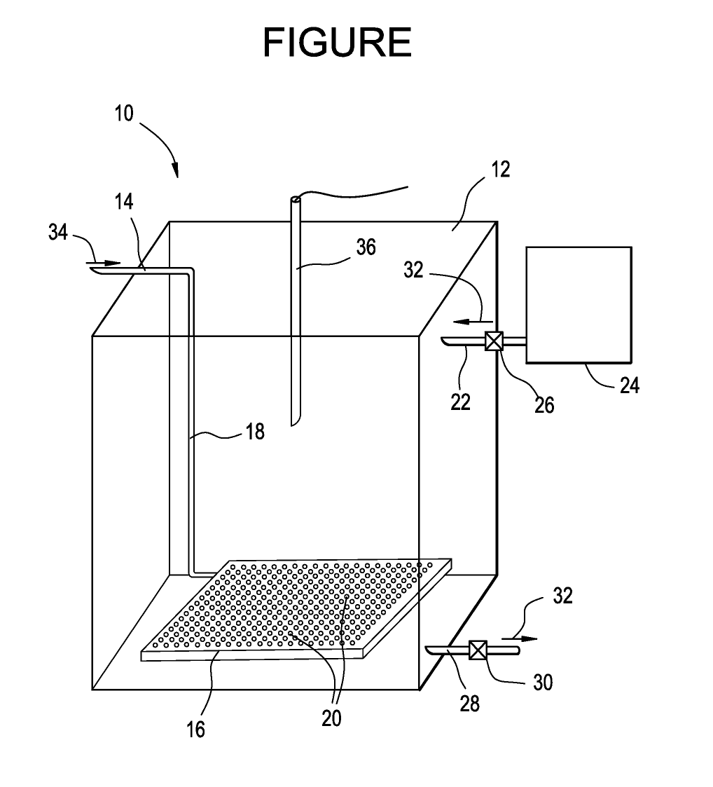

### BACKGROUND OF THE INVENTION

The subject matter disclosed herein relates to contaminant detection in an airflow. More specifically, the subject disclosure relates to detection of corrosive materials in an airflow.

Corrosive material detection in an airflow is typically accomplished by leaving material samples, for example, metal strips, in area to be tested. The material samples are left for an extended period of time and whatever contaminants are in the airflow around the material samples will be deposited thereon. The samples are then sent to a laboratory for analysis to determine what, if any, corrosive contaminants are in the airflow. This method is time consuming and only useful is measurements taken over a long-term timeframe.

In many instances, it is desired to have a real-time detection of contaminants in an airflow. For example, in an environment where a turbomachine is operating, it is desired to detect aerosolized salts and acids in the ambient air in which the turbomachine is operating, because these materials are known to cause corrosion of turbine components.

### BRIEF DESCRIPTION OF THE INVENTION

According to one aspect of the invention, a method for detecting particles in an airflow includes urging an airflow from a desired source location into a volume of water. The airflow is mixed into the volume of water, and particles from the airflow are dissolved in the volume of water. A change in a property of the volume water is measured via a detection probe, indicative of an amount of particles present in the volume of water.

According to another aspect of the invention, a system for detecting particles in an airflow includes a container configured to contain a volume of water and an airflow inlet in the container configured to introduce an airflow into the volume of water from a desired source location. A detection probe is located in the container to detect changes in a selected property of the volume of water after introduction of the airflow into the volume of water thereby indicating presence of particles in the airflow.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

The FIGURE is a schematic view of an embodiment of a corrosive particle detection system.

The detailed description explains embodiments of the invention, together with advantages and features, by way of example with reference to the drawings.

### DETAILED DESCRIPTION OF THE INVENTION

Shown in the FIGURE is an embodiment of a contaminant detection system 10. The system 10 includes a container 12 having an air inlet 14. A bubbler plate 16 is located in the container 10 and connected to the air inlet 14 via an air conduit 18. The bubbler plate 16 includes a plurality of bubbler holes 20. Air flowing through the air conduit 18 from the air inlet 14 is distributed to the plurality of bubbler holes 20 and exits the bubbler plate 16 therefrom.

The container 12 includes a water inlet 22 connected to a water source 24. In some embodiments, the water source 24 is a deionized water source. An inlet control valve 26 may be located between the water inlet 22 and the water source 24 to control a flow of water into the container 12. The container 12 further includes a water outlet 28 which may include an outlet control valve 30 to control flow of water from the container 12.

To detect contaminants, a flow of water 32, in some embodiments deionized water, is flowed from the water source 24 and through the water inlet 22 into the container 12. The container 12 is filled to a desired level with the water 32, at least covering the bubbler plate 16. When the water 32 reaches the desired level, the inlet control valve 26 may be closed to stop the flow of water 32 into the container 12. A detection probe 36 is inserted into the water 32 in the container 12. The detection probe 36 is configured to measure properties of the water 32, for example, pH or conductivity of the water 32. An airflow 34 is then flowed from a desired location, for example, ambient air around a turbomachine, through the air inlet 14 and to the bubbler plate 16 via the air conduit 18. The airflow 34 exits the bubbler plate 16 via the bubbler holes 20 causing aeration and mixing of the water 32. Particles, for example, corrosive salts and/or acids, and gases in the airflow 34 are dissolved in the water 32. The particles may include chlorides such as sodium chloride, calcium chloride, hydrogen chloride, magnesium chloride, and/or sulfides such as hydrogen sulfide and potassium sulfide. It is to be appreciated that the types of particles enumerated herein are merely exemplary and other types of particles may be detected by the method and system described herein. The detection probe 36 again measures, for example, pH or conductivity, changes in which are indicative of changes in the amount of corrosive particles in the airflow 34. At desired intervals, the outlet control valve 30 is opened and the container 12 is drained through the water outlet 28. The container 12 can then be refilled with water 32 and the process repeated.

The system and process described herein provides quick response monitoring and detection of corrosive particles in the airflow, relative to the methods of the prior art. Further, the salts and acids aerosolize when exposed to the water 32 in the container 12 making their detection easier than when directly detecting such particles in the airflow 34. Since the detection occurs in the water-filled container 12, the success of detection does not depend on the moisture content of the airflow 34.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for detecting particles in an airflow comprising:
urging an airflow from a desired source location into a volume of water; and
mixing the airflow into the volume of water;
dissolving particles from the airflow in the volume of water; and
measuring a change in a property of the volume water via a detection probe, the change being indicative of an amount of particles being present in the volume of water.

2. The method of claim 1, wherein the property is at least one of pH and conductivity.

3. The method of claim 1, including flowing the airflow through a bubbler plate to mix the airflow with the volume of water.

4. The method of claim 1, wherein the particles are at least one of corrosive salts and acids.

5. The method of claim 1, wherein the volume of water is disposed in a container.

6. The method of claim 5, further comprising draining the container.

7. The method of claim 1, wherein the airflow is flowed from ambient air around a turbomachine.

8. The method of claim 1, wherein the water is deionized water.

9. A system for detecting contaminants in an airflow comprising:
a container configured to contain a volume of water;
an airflow inlet in the container configured to introduce an airflow into the volume of water from a desired source location; and
a detection probe located in the container to detect changes in a selected property of the volume of water after introduction of the airflow into the volume of water thereby indicating presence of particles in the airflow.

10. The system of claim 9, wherein the property is at least one of pH and conductivity.

11. The system of claim 9, further comprising a bubbler plate disposed in the container through which the airflow is flowed into the volume of water.

12. The system of claim 11, wherein flowing the airflow through the bubbler plate aerates the volume of water and mixes components of the airflow with the volume of water.

13. The system of claim 9, wherein the contaminants are at least one of corrosive salts and acids.

14. The system of claim 9, further comprising a water outlet in the container to allow for draining of the container.

15. The system of claim 9, wherein the airflow is flowed from ambient air around a turbomachine.

16. The system of claim 9, wherein the water is deionized water.
